(19) United States
(12) Patent Application Publication
(10) Pub. No.: US 2024/0346256 A1
(43) Pub. Date: Oct. 17, 2024

(54) RESPONSE GENERATION USING A RETRIEVAL AUGMENTED AI MODEL

(71) Applicant: Microsoft Technology Licensing, LLC, Redmond, WA (US)

(72) Inventor: Yinghua QIN, Redmond, WA (US)

(21) Appl. No.: 18/299,352

(22) Filed: Apr. 12, 2023

(51) Int. Cl. G06F 40/40

(52) U.S. Cl. CPC G06F 40/40

(57) ABSTRACT

Systems, methods, apparatuses, and computer program products are disclosed for using retrieval augmented artificial intelligence to generate a response to a query. A first feature vector is generated based at least on the query. The first feature vector is compared to a plurality of second feature vectors to determine a subset of the second feature vectors that satisfy a predetermined condition. Augmentation information corresponding to the determined subset of second feature vectors are retrieved. An augmented prompt, generated based on the query and the retrieved augmentation information, is provided to a large language model. A response generated by the large language model is received.

### BACKGROUND

Large language models (LLM) are machine learning models that are designed to generate human-like text for a wide range of applications, including chatbots, language translation, and content creation. LLMs are typically trained on massive amounts of text using deep learning algorithms, and can generate text on a wide range of topics and subjects.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, apparatuses, and computer program products are disclosed for using retrieval augmented artificial intelligence to generate a response to a query. A first feature vector is generated based at least on the query. The first feature vector is compared to a plurality of second feature vectors to determine a subset of the second feature vectors that satisfy a predetermined condition. Augmentation information corresponding to the determined subset of second feature vectors are retrieved. An augmented prompt, generated based on the query and the retrieved augmentation information, is provided to a large language model. A response generated by the large language model is received.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for retrieval augmented response generation, in accordance with an embodiment.

FIG. 2 shows a block diagram of an example system for retrieval augmented response generation, in accordance with an embodiment.

FIG. 3 depicts a flowchart of a process for retrieval augmented response generation, in accordance with an embodiment.

FIGS. 4A and 4B depict flowcharts of processes for encoding low-dimensional dense vectors, in accordance with an embodiment.

FIG. 5 depicts a flowchart of a process for comparing feature vectors, in accordance with an embodiment.

FIGS. 6A-6C depict flowcharts of processes for selecting second feature vectors, in accordance with an embodiment.

FIG. 7 depicts a flowchart of a process for generating feature vectors, in accordance with an embodiment.

FIG. 8 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Large language models (LLM) (e.g., ChatGPT™ developed by OpenAI) are machine learning models designed to generate human-like text for a wide range of applications, including chatbots, language translation, and content creation. LLMs are typically trained on massive amounts of input text using deep learning algorithms, and can generate output text on a wide range of topics and subjects. However, the knowledge of an LLM is limited by the information present in its training data. As such, responses from LLMs may not always be relevant or accurate.

The ability of LLMs to generate human-like text on a wide range of topics and subjects stems from the massive amounts of text used to train the LLMs. However, the accuracy and relevancy of LLMs are limited by the information present in their training data. For instance, when an LLM is presented with a prompt that may have multiple correct answers, the LLM may respond with a generic answer that may not be very relevant. Furthermore, when faced with prompts directed to topics not included in its training data (e.g., corporate, or proprietary knowledgebases), LLMs may hallucinate by providing irrelevant or even false information. Additionally, the computational costs required to train an LLM limit the frequency at which the LLM is retrained with new or updated training data. As such, an LLM may generate inaccurate responses based on stale data (e.g., facts that are no longer true).

Embodiments are disclosed herein that improve the scope and accuracy of responses generated by an LLM. For instance, in embodiments, an LLM may be augmented with augmentation information (e.g., domain-specific information; entity-specific information; product-specific information; recent information unavailable at generation of the large language model; or information changed after generation of the large language model). A retrieval augmented generation (RAG) approach is disclosed herein that adds an information retrieval component to create augmented prompts to feed into the generative language model for generating the final answer/prediction. RAG is a general-purpose fine-tuning which combines pre-trained parametric and non-parametric memory for language generation. The pre-trained LLM such as GPT3 contains parametric memory. The non-parametric memory is a vector dictionary. A knowledge base is built for domain-specific content. This is accomplished with “dense vector embeddings”, which are numerical representations of the meaning behind content/sentences.

In on implementation, a query may be used to retrieve pieces of augmentation information that may be included in a prompt to the LLM. For instance, a query string may be encoded into a first feature vector that is compared to a plurality of second feature vectors to determine a subset of the second feature vectors that satisfy a predetermined condition (e.g., threshold similarity). Augmentation information corresponding to the determined subset of second feature vectors may be retrieved and included in an augmented prompt to the LLM. In embodiments, the augmented prompt may include the original query, contextual information for answering the query, the retrieved augmentation information, and/or a request to answer the original query based on the contextual information and/or the retrieved augmentation information. When presented with the retrieved augmentation information, the LLM prioritizes the retrieved augmentation information over the information present in its training data when generating a response to the query. Queries generated based on the augmented information have the benefit of generally more focused and accurate, and thus generate answers more relevant to users. As such, embodiments save users the time and effort of having to manually refine their own queries to eventually converge on relevant answers.

For instance, a non-augmented prompt presented to an LLM may include a single part, which may be the original query, such as the following example:
What is the licensing model for product A?

In contrast, a prompt generator configured according to an embodiment, may generate the following augmented prompt, which includes three parts, including context, content, and a question, and thus includes two parts in addition to the non-augmented question:
Please answer the following question using the provided context and content.
Context: [e.g., current webpage, the product or service associated with the current webpage, temporal information, location, etc.].
Content: [Text of the retrieved augmentation information (e.g., content of document(s) related to product A′s internal licensing)].
Question: What is the licensing model for product A?

In an embodiment, the prompt generator provides the augmented prompt with the retrieved augmentation information to the LLM. In an embodiment, the LLM receives the augmented prompt with the contextual information and/or the augmentation information and generates a response to the original query.

Augmenting an LLM with retrieved augmentation information may improve responses in a variety of situations. For instance, a search engine or chatbot on an internal corporate website may provide employees with accurate responses when presented with a query that is directed to internal or proprietary information. In another example, an external-facing company webpage may provide customers with responses that are focused on the company's products or services. In yet another example, an LLM may be augmented with new or changed information to improve the accuracy of responses of the LLM based on recent information that was unavailable at generation of the LLM and/or information that has changed after generation of the LLM.

These and further embodiments are disclosed herein that enable the functionality described above and further such functionality. Such embodiments are described in further detail as follows.

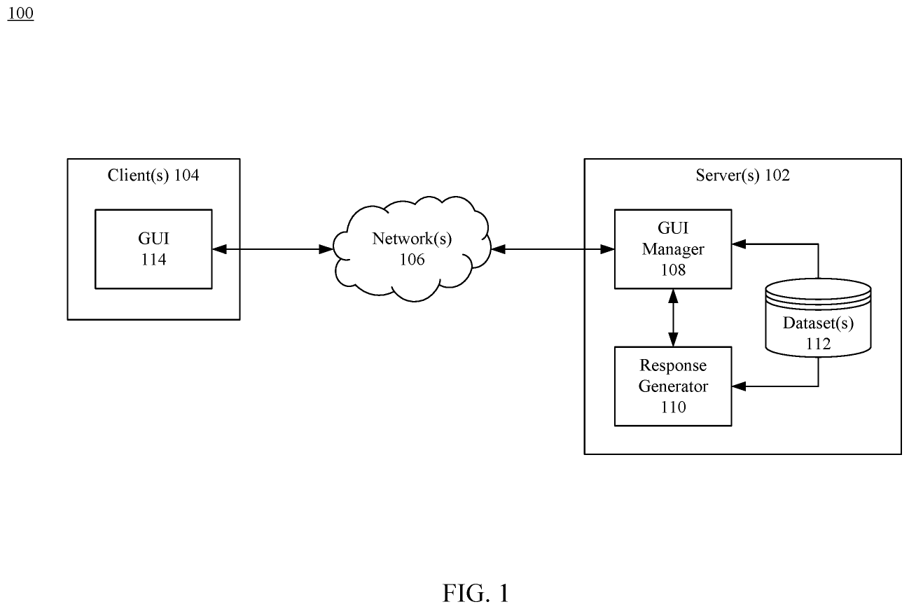

For instance, FIG. 1 shows a block diagram of an example system 100 for generating a response using a retrieval augmented LLM, in accordance with an embodiment. As shown in FIG. 1, system 100 may include one or more servers 102 connected to one or more clients 104 via one or more networks 106. One or more of servers 102 may further include a graphical user interface (GUI) manager 108, a response generator 110, and one or more datasets 112. Each of clients 104 may further include a GUI 114.

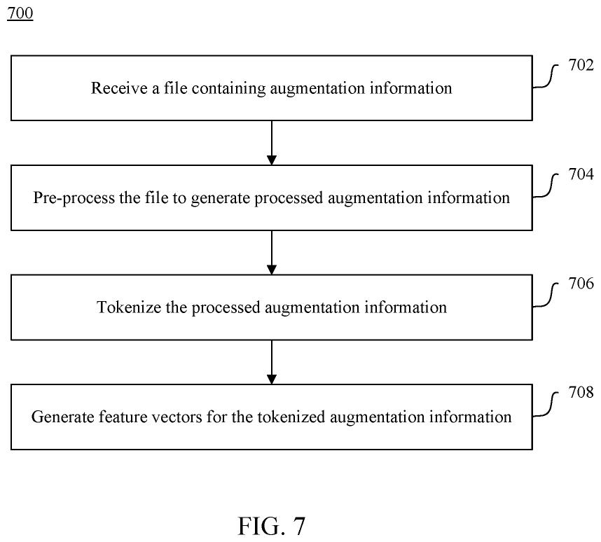

Server(s) 102 may include any computing device suitable for performing functions that are ascribed thereto in the following description, as will be appreciated by persons skilled in the relevant art(s), including those mentioned elsewhere herein or otherwise known. Various example implementations of server(s) 102 are described below in reference to FIG. 7 (e.g., computing device 702, network-based server infrastructure 770, and/or on-premises servers 792).

Each of clients 104 may include any computing device suitable for performing functions that are ascribed thereto in the following description, as will be appreciated by persons skilled in the relevant art(s), including those mentioned elsewhere herein or otherwise known. Various example implementations of client(s) 104 and server(s) 102 are described below in reference to FIG. 7.

Network(s) 106 may comprise one or more networks such as local area networks (LANs), wide area networks (WANs), personal area network (PANs), enterprise networks, the Internet, etc., and may include wired and/or wireless portions. Server(s) 102 and client(s) 104 may be communicatively coupled via network(s) 106. Examples of network(s) 106 include those described below in reference to network 704 of FIG. 7.

GUI manager 108 may comprise one or more back-end components to communicate with GUI 114 on client(s) 104. In an embodiment, GUI manager 108 receives a query from GUI 114 and provides the query to response generator 110. GUI manager 108 may also provide a response from response generator 110 to GUI 114. In embodiments. GUI manager 108 may also access dataset(s) 112 to retrieve and/or generate content for the response.

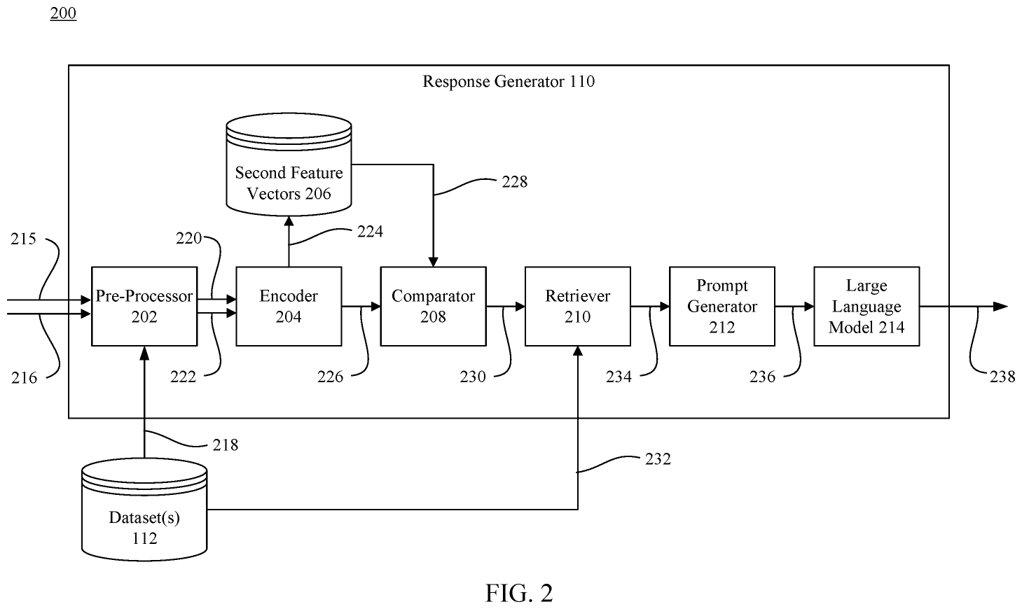

Response generator 110 generates a response to the query. In embodiments, response generator 110 may generate the response based on augmentation information from dataset(s) 112. Response generator 110 will be described in greater detail below in conjunction with FIG. 2.

Dataset(s) 112 may include one or more databases storing augmentation information that is used to respond to the query from GUI 114. In embodiments, augmentation information stored in dataset(s) 112 may include, but are not limited to, domain-specific information (e.g., information related to specific topics or fields), entity-specific information (e.g., internal or proprietary corporate information), product-specific information (e.g., information related to products of an entity), recent information unavailable at generation of the large language model (e.g., new facts that postdate the generation of the LLM), and/or information changed after generation of the large language model (e.g., facts that have changed since the generation of the LLM). In embodiments, augmentation information may be stored in dataset(s) 112 in a variety of formats, including, but not limited to, in a database (e.g., SQL, etc.), in one or more markup languages (e.g., HTML, XML, Markdown, etc.), in one or more file formats (e.g., .pdf, .doc, etc.), and the like.

GUI 114 may comprise one or more front-end components to communicate with response generator 110 via GUI manager 108 on server(s) 102. In embodiments, GUI 114 may include, but is not limited to, a web-based application, a webpage, a mobile application, a desktop application, a remotely executed server application, and the like.

In embodiments, response generator 110 employs an LLM to generate a response to the query. For instance, FIG. 2 shows a block diagram of an example system for employing a retrieval augmented LLM for response generation in accordance with an embodiment. As shown in FIG. 2, system 200 includes response generator 110 and dataset(s) 112 as shown and described with respect to FIG. 1. Response generator 110 further includes a pre-processor 202, an encoder 204, a plurality of second feature vectors 206, a comparator 208, a retriever 210, a prompt generator 212, and a large language model (LLM) 214. These features of system 200 are described in further detail as follows.

Pre-processor 202 may receive contextual information 215 and/or query 216. In embodiments, contextual information 215 may describe the context of the user (e.g., user identifier, user role, user profile, user location, browsing history, etc.) and/or the context of the query (e.g., the current webpage, the product or service associated with the current webpage, query timestamp information, etc.). In embodiments, query 216 may include a question in the form of a text string or voice data. In embodiments, pre-processor 202 may process query 216 to generate a query text string 220 based on query 216. In embodiments, pre-processor 202 may process voice data using voice recognition technologies to generate query text string 220. In embodiments, pre-processor 202 may perform language translation on query 216. In embodiments, pre-processor 202 may further include some or all of contextual information 215 in query text string 220. Query text string 220 may be provided to encoder 204.

In embodiments, pre-processor 202 may also receive augmentation information 218 from dataset(s) 112. As discussed above, augmentation information 218 may include, but is not limited to, domain-specific information, entity-specific information, product-specific information, recent information unavailable at generation of the large language model, and/or information changed after generation of the large language model. In embodiments, augmentation information 218 may further include metadata (e.g., product identifier) associated with augmentation information 218. In embodiments, pre-processor 202 may process augmentation information 218 to generate an augmentation information text string 222 based on augmentation information 218. For instance, pre-processor 202 may remove markup language (e.g., HTML, XML, PDF, Markdown, etc.) elements (e.g., tags, syntax, formatting, etc.) from augmentation information 218. In embodiments, pre-processor may extract metadata (e.g., temporal information, image descriptors, etc.) from augmentation information 218 and include the extracted metadata in augmentation information text string 222. Augmentation information text string 222 may be provided to encoder 204.

Encoder 204 may include one or more encoders that generate feature vectors based on a text string. For instance, encoder 204 may process query text string 220 to generate a first feature vector 226 that represents the meaning of query text string 220. Encoder 204 may provide first feature vector 226 to comparator 208. In embodiments, encoder 204 may also process augmentation information text string 222 to generate a second feature vector 224 that represents the meaning of augmentation information text string 222. In embodiments, a second feature vector 224 may be generated for each piece of augmentation information in dataset(s) 112 and stored as second feature vectors 206 for future use. In embodiments, the generation of first feature vector 226 may prior to, concurrently, or after the generation of second feature vector 224.

In embodiments, encoder 204 may comprise a Generative Pre-Trained Transformer (GPT)-based or a Bidirectional Encoder Representations from Transformers (BERT)-based encoder. In embodiments, encoder 204 may tokenize query text string 220 and/or augmentation information text string 222 to generate a plurality of tokens. Encoder 204 may then generate embeddings for each token. In embodiments, the generated embeddings are numerical vectors that represent the meaning and context of the tokens. Encoder 204 may then aggregate the embeddings for each token to form a sentence embedding vector that represents the meaning of the text. For example, first feature vector 226 and/or second feature vector 224 may include, but are not limited to, low-dimensional dense vectors that are generated using dense embedding models (e.g., Word2Vec or the like) and/or transformer models (e.g., BERT).

Comparator 208 may include one or more comparators configured to determine the similarity between two feature vectors. In an embodiment, comparator 208 receives first feature vector 226 from encoder 204 and second feature vectors 228 from second feature vectors 206, and compares first feature vector 226 to second feature vectors 228 to determine the similarity between first feature vector 226 and second feature vectors 228. For example, comparator 208 may calculate a cosine similarity between first feature vector 226 and cach second feature vector 228 to determine second feature vectors that are most similar to first feature vector 226. In embodiments, the cosine similarity is a value between zero (0.0) and one (1.0), inclusively, with a value of zero indicating no similarity between the feature vectors and a value of one indicating identical feature vectors.

In embodiments, comparator 208 provides one or more indications 230 to retriever 210. For example, indication(s) 230 may include, but are not limited to, identifiers of second feature vectors that are most similar to first feature vector 226 along with a corresponding cosine similarity score indicating the similarity to first feature vector 226, and/or identifiers of pieces of augmentation information that correspond to the second feature vectors 228 that are most similar to first feature vector 226.

Retriever 210 may be configured to determine and retrieve pieces of augmentation information from dataset(s) 112. In embodiments, retriever 210 may receive and analyze indication(s) 230 to identify and retrieve one or more pieces of augmentation information 232 from dataset(s) 112. For example, retriever 210 may identify and retrieve augmentation information 232 that correspond to the second feature vectors having a cosine similarity to the first feature vector that satisfies a first predetermined relationship with a first predetermined threshold, that correspond to a first predetermined number of second feature vectors having the highest cosine similarities to the first feature vector, and/or that correspond to a second predetermined number of second feature vectors having the highest cosine similarities to the first feature vector that satisfy a second predetermined relationship with a second predetermined threshold. In embodiments, retriever 210 may provide augmentation information 232 to prompt generator 212 as part of contextual information 234. In embodiments, contextual information 234 may further include one or more of contextual information 215, query 216, first feature vector 226, one or more of second feature vectors 228, and/or indication(s) 230. In embodiments, retriever 210 may determine from indication(s) 230 that no second feature vectors have a cosine similarity to the first feature vector that satisfies a first predetermined with a first threshold, and does not provide any augmentation information to prompt generator 212.

Prompt generator 212 may generate a prompt for LLM 214 based on one or more of query 216, first feature vector 226, one or more of second feature vectors 228, indications 230, and/or augmentation information 232. For example, prompt generator 212 may generate an augmented prompt 236 that includes the original query, contextual information (e.g., the current webpage, the product or service of the current webpage, temporal information, location information, etc.), content information (e.g., the retrieved augmentation information 232), and a request to answer the original query based on the provided contextual information using the included content information. For example, prompt generator 212 may employ natural language processing (NLP) techniques to generate an augmented prompt 236 that requests LLM 214 to respond to query 216 based on contextual information using augmentation information 232. In embodiments, augmented prompt 236 may include, identify and/or link to augmentation information 232. Prompt generator 212 provides augmented prompt 236 to LLM 214. In embodiments, prompt generator 212 may determine that no second feature vectors have a cosine similarity to the first feature vector that satisfies a first predetermined with a first threshold, and provide a non-augmented prompt (e.g., query 216) or a partially augmented prompt (e.g., query 216 augmented with contextual information 215) to LLM 214.

In embodiments, LLM 214 receives augmented prompt 236 from prompt generator 212 and generates response 238. For example, LLM 214 may process prompt augmented 236 to generate a response 238 based on contextual information 215 using augmentation information 232. In embodiments, LLM 214 prioritizes augmentation information 232 over information in its training data when generating the response 238. In embodiments, LLM 214 may determine that augmentation information 232 does not contain an answer to the query and may generate a response that is not based on augmentation information 232. For instance, LLM 214 may respond by indicating that it does not know the answer to the query, by generating a response based on the information in its training data, and/or by asking the user to clarify their query.

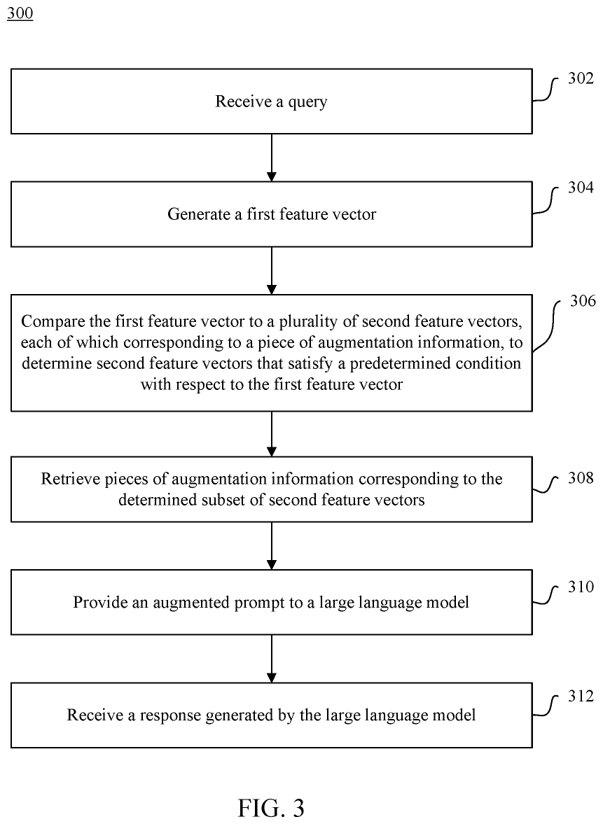

Embodiments described herein may operate in various ways to generate a response using a retrieval augmented LLM. For instance, FIG. 3 depicts a flowchart 300 of a process for generating a response using a retrieval augmented LLM, in accordance with an embodiment. Server(s) 102 of FIG. 1 and/or response generator 110 of FIGS. 1 and 2 may operate according to flowchart 300, for example. Note that not all steps of flowchart 300 may need to be performed in all embodiments, and in some embodiments, the steps of flowchart 300 may be performed in different orders than shown. Flowchart 300 is described as follows with respect to FIGS. 1 and 2 for illustrative purposes.

Flowchart 300 starts at step 302. In Step 302, a query is received. For instance, pre-processor 202 of response generator 110 may receive query 216. As described above, In embodiments, query 216 may include a question in the form of a text string or voice data. In embodiments, pre-processor 202 generates a query text string 220 based on query 216 and provides query text string 220 to encoder 204.

In step 304, a first feature vector is generated. For instance, encoder 204 may generate first feature vector 226 that represents the meaning of query text string 220. As discussed above, encoder 204 may comprise a GPT-based or a BERT-based encoder that is configured to generate low-dimensional dense vectors. In embodiments, encoder 204 provides first feature vector 226 to comparator 208.

In step 306, the first feature vector is compared to a plurality of second feature vectors, each of which corresponding to a piece of augmentation information, to determine second feature vectors that satisfy a predetermined condition with respect to the first feature vector. For instance, comparator 208 may compare first feature vector 226 to second feature vectors 228. As discussed above, comparator 208 may calculate a cosine similarity between first feature vector 226 and each second feature vector 228 to determine second feature vectors that are most similar to first feature vector 226. For instance, comparator 208 may compare first feature vector 226 to second feature vectors 228 to determine second feature vectors that are most similar to first feature vector 226. As discussed above, the determined second feature vectors may include second feature vectors having a cosine similarity to the first feature vector that satisfies a first predetermined relationship with a first predetermined threshold, second feature vectors that correspond to a first predetermined number of second feature vectors having the highest cosine similarities to the first feature vector, and/or second feature vectors that correspond to a second predetermined number of second feature vectors having the highest cosine similarities to the first feature vector that satisfy a second predetermined relationship with a second predetermined threshold. In embodiments, comparator 208 may provide, to retriever 210, indication(s) 230 that correspond to the second feature vectors 228 that are most similar to first feature vector 226. As discussed above, indication(s) 230 may include, but are not limited to, identifiers of second feature vectors that are most similar to first feature vector 226 along with a corresponding cosine similarity score indicating the similarity to first feature vector 226, and/or identifiers of augmentation information that correspond to the second feature vectors 228 that are most similar to first feature vector 226.

In step 308, pieces of augmentation information corresponding to the determined second feature vectors are retrieved. For instance, retriever 210 may retrieve augmentation information 232 from dataset(s) 112 that correspond to the indication(s) 230. As discussed above, retriever 210 may analyze indication(s) 230 received from comparator 208 to identify and retrieve augmentation information 232 from dataset(s) 112. For example, retriever 210 may identify and retrieve augmentation information 232 that correspond to the second feature vectors having a cosine similarity to the first feature vector that satisfies a first predetermined relationship with a first predetermined threshold, that correspond to a first predetermined number of second feature vectors having the highest cosine similarities to the first feature vector, and/or that correspond to a second predetermined number of second feature vectors having the highest cosine similarities to the first feature vector that satisfy a second predetermined relationship with a second predetermined threshold. In embodiments, retriever 210 may provide augmentation information 232 to prompt generator 212 as part of contextual information 234. In embodiments, contextual information 234 may further include one or more of query 216, first feature vector 226, one or more of second feature vectors 228, and/or indications 230.

In step 310, an augmented prompt is provided to a large language model. For instance, prompt generator 212 may generate and provide augmented prompt 236 to LLM 214. As discussed above, prompt generator 212 may employ natural language processing (NLP) techniques to generate an augmented prompt 236 that requests LLM 214 to respond to query 216 based on contextual information 215 using augmentation information 232. In embodiments, augmented prompt 236 may include, identify and/or link to augmentation information 232.

In step 312, a response generated by the large language model is received. For instance, GUI manager 108 may receive from response generator 110 a response 238 generated by LLM 214. As discussed above, LLM 214 may process augmented prompt 236 to generate a response 238 based on contextual information 215 using augmentation information 232. In embodiments, LLM 214 prioritizes augmentation information 232 over information in its training data when generating the response 238. In embodiments, LLM 214 may determine that augmentation information 232 does not contain an answer to the query and may generate a response that is not based on augmentation information 232. For instance, LLM 214 may respond by indicating that it does not know the answer to the query, by generating a response based on the information in its training data, and/or by asking the user to clarify their query.

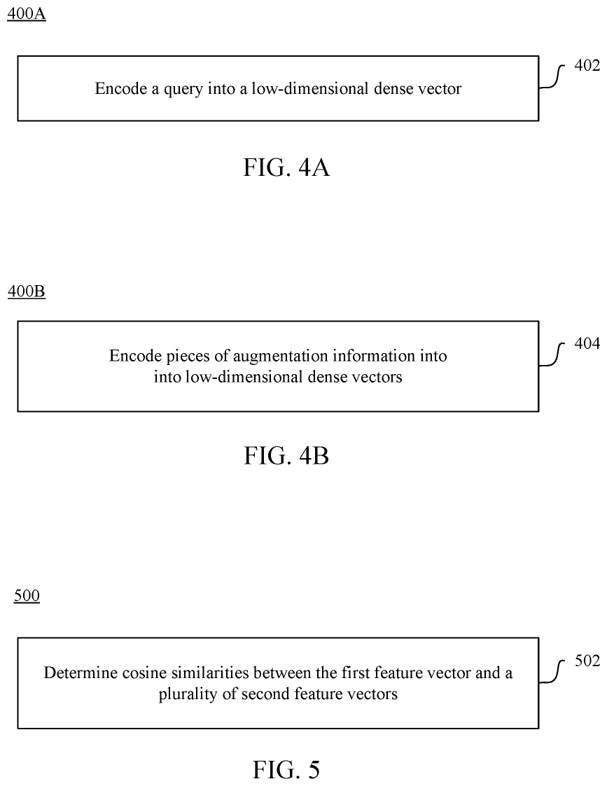

Embodiments disclosed herein may operate in various ways to encode a text string into low-dimensional dense vectors. For instance, FIGS. 4A and 4B depict flowcharts 400A and 400B, respectively, of processes for encoding text strings into low-dimensional dense vectors, in accordance with an embodiment. Server(s) 102 of FIG. 1 and/or encoder 204 of response generator 110 of FIGS. 1 and 2 may operate according to flowcharts 400A and 400B, for example. Flowcharts 400A and 400B are described as follows with respect to FIGS. 1 and 2 for illustrative purposes.

Flowchart 400A starts at step 402. In step 402, a concatenation of user contextual information is encoded into a low-dimensional dense vector. For instance, encoder 204 may encode query text string 220 into first feature vector 226. In embodiments, encoder 204 tokenizes query text string 220 into tokens and generates embeddings comprising numerical vectors for each token. Encoder 204 may then aggregate the embeddings for each token to form first feature vector 226 that represents the meaning of query text string 220.

Flowchart 400B starts at step 404. In step 402, a concatenation of user historical information, product information, and content information is encoded into a low-dimensional dense vector. For instance, encoder 204 may encode augmentation information text string 222 into second feature vector 224. In embodiments, encoder 204 tokenizes augmentation information text string 222 into tokens and generates embeddings comprising numerical vectors for each token. Encoder 204 may then aggregate the embeddings for each token to form second feature vector 224 that represents the meaning of augmentation information text string 222. In embodiments, encoder 204 may generate a second feature vector 224 for each piece of augmentation information in dataset(s) 112 and store the generated second feature vectors 224 as second feature vectors 206 for future use.

Embodiments disclosed herein may operate in various ways to compare a first feature vector to second feature vectors. For instance, FIG. 5 depicts a flowchart 500 of a process for determining cosine similarities between a first feature vector and a plurality of second feature vectors, in accordance with an embodiment. Server(s) 102 of FIG. 1 and/or comparator 208 of response generator 110 of FIGS. 1 and 2 may operate according to flowchart 500, for example. Flowchart 500 is described as follows with respect to FIGS. 1 and 2 for illustrative purposes.

Flowchart 500 starts at step 502. In step 502, cosine similarities are determined between at least a portion of a first feature vector and corresponding portions of a plurality of second feature vectors. For instance, comparator 208 may determine cosine similarities between at least a portion of first feature vector 226 and corresponding portions of second feature vectors 228. To calculate cosine similarity between the first feature vector 226 and a second feature vector 228, we divide the dot product of the two vectors by the product of the magnitudes of the two vectors. The resulting value is the cosine of the angle between the two vectors with a value between −1.0 and 1.0, inclusive. This cosine value is a measure of similarity, where 1.0 means the vectors are identical, 0.0 means they are orthogonal (i.e., unrelated), and −1.0 means they are opposite.

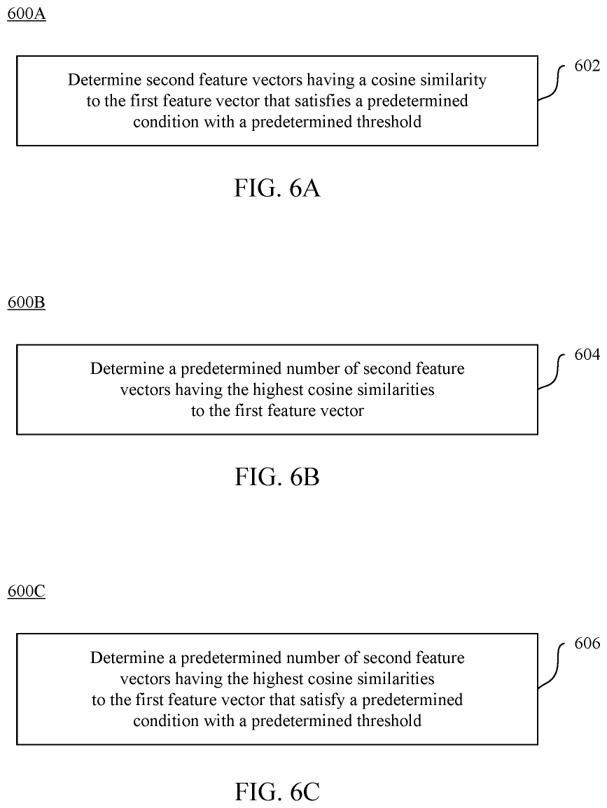

Embodiments disclosed herein may operate in various ways to determine second feature vectors that are similar to a first feature vector. For instance, FIGS. 6A-6C depict flowcharts 600A-600C, respectively, of processes for determining second feature vectors based on their cosine similarity to a first feature vector, in accordance with an embodiment. Server(s) 102 of FIG. 1 and/or comparator 208 and/or retriever 210 of response generator 110 of FIGS. 1 and 2 may operate according to flowcharts 600A-600C, for example. Note that not all steps of flowcharts 600A-600C may need to be performed in all embodiments, and in some embodiments, the steps of flowcharts 600A-600C may be performed in the alternative. Flowcharts 600A-600C are described as follows with respect to FIGS. 1 and 2 for illustrative purposes.

Flowchart 600A starts at step 602. In step 602, second feature vectors having a cosine similarity to the first feature vector that satisfies a predetermined condition with a predetermined threshold are determined. For instance, comparator 208 may calculate the cosine similarities between first feature vector 226 and a plurality of second feature vectors 228. Comparator 208 and/or retriever 210 may determine second feature vectors having calculated cosine similarities that satisfy a predetermined condition with a predetermined threshold. For example, comparator 208 and/or retriever 210 may determine second feature vectors having a calculated cosine similarity values greater than a predetermined threshold (e.g., 0.8).

Flowchart 600B starts at step 604. In step 604, a predetermined number of second feature vectors having the highest cosine similarity to the first feature vector are determined. For instance, comparator 208 may calculate the cosine similarities between first feature vector 226 and a plurality of second feature vectors 228. Comparator 208 and/or retriever 210 may determine a predetermined number (e.g., 3) of second feature vectors having the highest calculated cosine similarities.

Flowchart 600C starts at step 606. In step 606, a predetermined number of second feature vectors having the highest cosine similarities to the first feature vector that satisfy a predetermined condition with a predetermined threshold are determined. For instance, comparator 208 may calculate the cosine similarities between first feature vector 226 and a plurality of second feature vectors 228. Comparator 208 and/or retriever 210 may determine a predetermined number of second feature vectors having the highest calculated cosine similarities that satisfy a predetermined condition with a predetermined threshold. For example, comparator 208 and/or retriever 210 may determine the four (or any other number of) second feature vectors having the highest calculated cosine similarities greater than a predetermined threshold (e.g., 0.7). In embodiments, the predetermined number, the predetermined condition and/or the predetermined threshold associated with flowchart 600C may be the same as, or different from, the predetermined number, the predetermined condition and/or the predetermined threshold associated with flowcharts 600A and/or 600B.

Embodiments disclosed herein may operate in various ways to generate feature vectors. For instance, FIG. 7 depicts a flowchart 700 of a process for generating feature vectors, in accordance with an embodiment. Server(s) 102 of FIG. 1 and/or pre-processor 202 and/or encoder 204 of response generator 110 of FIGS. 1 and 2 may operate according to flowchart 700, for example. Note that not all steps of flowchart 700 may need to be performed in all embodiments, and in some embodiments, the steps of flowchart 700 may be performed in different orders than shown. Flowchart 700 is described as follows with respect to FIGS. 1 and 2 for illustrative purposes.

Flowchart 700 starts at step 702. In step 702 a file containing augmentation information is received. For instance, pre-processor 202 may receive augmentation information 218 in the form of a file. As discussed above, augmentation information 218 may include, but is not limited to, domain-specific information, entity-specific information, product-specific information, recent information unavailable at generation of the large language model, and/or information changed after generation of the large language model.

In step 704, the file is pre-processed to generate processed augmentation information. For instance, pre-processor 202 may process augmentation information 218 to generate an augmentation information text string 222 based on augmentation information 218. For instance, pre-processor 202 may remove markup language (e.g., HTML, XML, PDF. Markdown, etc.) elements (e.g., tags, syntax, formatting, etc.) from augmentation information 218. In embodiments, pre-processor may extract metadata (e.g., temporal information, image descriptors, etc.) from augmentation information 218 and include the extracted metadata in augmentation information text string 222. Augmentation information text string 222 may be provided to encoder 204. In embodiments, pre-processor 202 may generate a plurality of augmentation text strings 222 from each file containing augmentation information. For example, pre-processor 202 may process the file into a plurality of augmentation information text strings 222 based on a predetermined length, or based on segmentation information present in the file (e.g., by section, sub-section, and/or paragraph.

In step 706, the processed augmentation information is tokenized. For example, encoder 204 may process each augmentation information text string 222 to generate a plurality of tokens. As discussed above, encoder 204 may comprise a Generative Pre-Trained Transformer (GPT)-based or a Bidirectional Encoder Representations from Transformers (BERT)-based encoder. In embodiments, the generated tokens may include one or more words and/or one or more sub-words of augmentation text string 222.

In step 708, feature vectors are generated for the tokenized augmentation information. For instance, Encoder 204 may generate a feature vectors that represent the meaning of each augmentation information text string 222. As discussed above, encoder 204 may generate embeddings for each of the generated tokens. In embodiments, the generated embeddings are numerical vectors that represent the meaning and context of the tokens. Encoder 204 may then aggregate the embeddings for each token to form a sentence embedding vector that represents the meaning of the entirety of augmentation information text string 222. For example, second feature vector 224 may include, but is not limited to, low-dimensional dense vectors that are generated using dense embedding models (e.g., Word2Vec or the like) and/or transformer models (e.g., BERT).

### III. Example Mobile Device and Computer System Implementation

The systems, methods, and computer-readable storage devices described above in reference to FIGS. 1-7, server(s) 102, client(s) 104, network(s) 106, GUI manager 108, response generator 110, dataset(s) 112, GUI 114, pre-processor 202, encoder 204, database of second feature vectors 206, comparator 208, retriever 210, prompt generator 212, large language model 214, and/or each of the components described therein, and/or the steps of flowcharts 300, 400A, 400B, 500, 600A, 600B, 600C and/or 700 may be each implemented as computer program code/instructions configured to be executed in one or more processors and stored in a computer readable storage medium. Alternatively, server(s) 102, client(s) 104, network(s) 106, GUI manager 108, response generator 110, dataset(s) 112, GUI 114, pre-processor 202, encoder 204, database of second feature vectors 206, comparator 208, retriever 210, prompt generator 212, large language model 214, and/or each of the components described therein, and/or the steps of flowcharts 300, 400A, 400B, 500, 600A, 600B, 600C and/or 700 may be implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

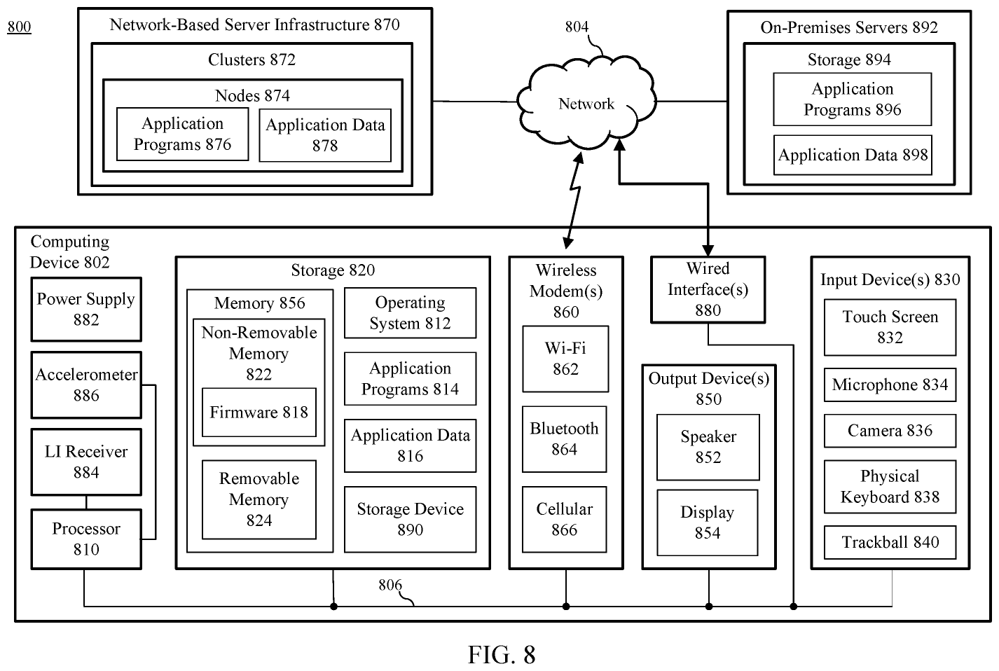

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 8. FIG. 8 shows a block diagram of an exemplary computing environment 800 that includes a computing device 802. In some embodiments, computing device 802 is communicatively coupled with devices (not shown in FIG. 8) external to computing environment 800 via network 804. Network 804 comprises one or more networks such as local area networks (LANs), wide area networks (WANs), enterprise networks, the Internet, etc., and may include one or more wired and/or wireless portions. Network 804 may additionally or alternatively include a cellular network for cellular communications. Computing device 802 is described in detail as follows

Computing device 802 can be any of a variety of types of computing devices. For example, computing device 802 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Quest 2® by Reality Labs, a division of Meta Platforms, Inc, etc.), or other type of mobile computing device. Computing device 802 may alternatively be a stationary computing device such as a desktop computer, a personal computer (PC), a stationary server device, a minicomputer, a mainframe, a supercomputer, etc.

As shown in FIG. 8, computing device 802 includes a variety of hardware and software components, including a processor 810, a storage 820, one or more input devices 830, one or more output devices 850, one or more wireless modems 860, one or more wired interfaces 880, a power supply 882, a location information (LI) receiver 884, and an accelerometer 886. Storage 820 includes memory 856, which includes non-removable memory 822 and removable memory 824, and a storage device 890. Storage 820 also stores an operating system 812, application programs 814, and application data 816. Wireless modem(s) 860 include a Wi-Fi modem 862, a Bluetooth modem 864, and a cellular modem 866. Output device(s) 850 includes a speaker 852 and a display 854. Input device(s) 830 includes a touch screen 832, a microphone 834, a camera 836, a physical keyboard 838, and a trackball 840. Not all components of computing device 802 shown in FIG. 8 are present in all embodiments, additional components not shown may be present, and any combination of the components may be present in a particular embodiment. These components of computing device 802 are described as follows.

A single processor 810 (e.g., central processing unit (CPU), microcontroller, a microprocessor, signal processor, ASIC (application specific integrated circuit), and/or other physical hardware processor circuit) or multiple processors 810 may be present in computing device 802 for performing such tasks as program execution, signal coding, data processing, input/output processing, power control, and/or other functions. Processor 810 may be a single-core or multi-core processor, and each processor core may be single-threaded or multithreaded (to provide multiple threads of execution concurrently). Processor 810 is configured to execute program code stored in a computer readable medium, such as program code of operating system 812 and application programs 814 stored in storage 820. Operating system 812 controls the allocation and usage of the components of computing device 802 and provides support for one or more application programs 814 (also referred to as “applications” or “apps”). Application programs 814 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 802 can communicate with any other component according to function, although not all connections are shown for case of illustration. For instance, as shown in FIG. 8, bus 806 is a multiple signal line communication medium (e.g., conductive traces in silicon, metal traces along a motherboard, wires, etc.) that may be present to communicatively couple processor 810 to various other components of computing device 802, although in other embodiments, an alternative bus, further buses, and/or one or more individual signal lines may be present to communicatively couple components. Bus 806 represents one or more of any of several types of bus structures, including a memory bus or memory controller, a peripheral bus, an accelerated graphics port, and a processor or local bus using any of a variety of bus architectures.

Storage 820 is physical storage that includes one or both of memory 856 and storage device 890, which store operating system 812, application programs 814, and application data 816 according to any distribution. Non-removable memory 822 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 822 may include main memory and may be separate from or fabricated in a same integrated circuit as processor 810. As shown in FIG. 8, non-removable memory 822 stores firmware 818, which may be present to provide low-level control of hardware. Examples of firmware 818 include BIOS (Basic Input/Output System, such as on personal computers) and boot firmware (e.g., on smart phones). Removable memory 824 may be inserted into a receptacle of or otherwise coupled to computing device 802 and can be removed by a user from computing device 802. Removable memory 824 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 890 may be present that are internal and/or external to a housing of computing device 802 and may or may not be removable. Examples of storage device 890 include a hard disk drive, a SSD, a thumb drive (e.g., a USB (Universal Serial Bus) flash drive), or other physical storage device.

One or more programs may be stored in storage 820. Such programs include operating system 812, one or more application programs 814, and other program modules and program data. Examples of such application programs may include, for example, computer program logic (e.g., computer program code/instructions) for implementing one or more of server(s) 102, client(s) 104, network(s) 106, GUI manager 108, response generator 110, dataset(s) 112, GUI 114, pre-processor 202, encoder 204, database of second feature vectors 206, comparator 208, retriever 210, prompt generator 212, large language model 214, and/or each of the components described therein, along with any components and/or subcomponents thereof, as well as the flowcharts/flow diagrams (e.g., flowcharts 300, 400A, 400B, 500, 600A, 600B, 600C and/or 700) described herein, including portions thereof, and/or further examples described herein.

Storage 820 also stores data used and/or generated by operating system 812 and application programs 814 as application data 816. Examples of application data 816 include web pages, text, images, tables, sound files, video data, and other data, which may also be sent to and/or received from one or more network servers or other devices via one or more wired or wireless networks. Storage 820 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 802 through one or more input devices 830 and may receive information from computing device 802 through one or more output devices 850. Input device(s) 830 may include one or more of touch screen 832, microphone 834, camera 836, physical keyboard 838 and/or trackball 840 and output device(s) 850 may include one or more of speaker 852 and display 854. Each of input device(s) 830 and output device(s) 850 may be integral to computing device 802 (e.g., built into a housing of computing device 802) or external to computing device 802 (e.g., communicatively coupled wired or wirelessly to computing device 802 via wired interface(s) 880 and/or wireless modem(s) 860). Further input devices 830 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 854 may display information, as well as operating as touch screen 832 by receiving user commands and/or other information (e.g., by touch, finger gestures, virtual keyboard, etc.) as a user interface. Any number of each type of input device(s) 830 and output device(s) 850 may be present, including multiple microphones 834, multiple cameras 836, multiple speakers 852, and/or multiple displays 854.

One or more wireless modems 860 can be coupled to antenna(s) (not shown) of computing device 802 and can support two-way communications between processor 810 and devices external to computing device 802 through network 804, as would be understood to persons skilled in the relevant art(s). Wireless modem 860 is shown generically and can include a cellular modem 866 for communicating with one or more cellular networks, such as a GSM network for data and voice communications within a single cellular network, between cellular networks, or between the mobile device and a public switched telephone network (PSTN). Wireless modem 860 may also or alternatively include other radio-based modem types, such as a Bluetooth modem 864 (also referred to as a “Bluetooth device”) and/or Wi-Fi 862 modem (also referred to as an “wireless adaptor”). Wi-Fi modem 862 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 864 is configured to communicate with another Bluetooth-capable device according to the Bluetooth short-range wireless technology standard(s) such as IEEE 802.15.1 and/or managed by the Bluetooth Special Interest Group (SIG).

Computing device 802 can further include power supply 882, LI receiver 884, accelerometer 886, and/or one or more wired interfaces 880. Example wired interfaces 880 include a USB port, IEEE 1394 (Fire Wire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 880 of computing device 802 provide for wired connections between computing device 802 and network 804, or between computing device 802 and one or more devices/peripherals when such devices/peripherals are external to computing device 802 (e.g., a pointing device, display 854, speaker 852, camera 836, physical keyboard 838, etc.). Power supply 882 is configured to supply power to each of the components of computing device 802 and may receive power from a battery internal to computing device 802, and/or from a power cord plugged into a power port of computing device 802 (e.g., a USB port, an A/C power port). LI receiver 884 may be used for location determination of computing device 802 and may include a satellite navigation receiver such as a Global Positioning System (GPS) receiver or may include other type of location determiner configured to determine location of computing device 802 based on received information (e.g., using cell tower triangulation, etc.). Accelerometer 886 may be present to determine an orientation of computing device 802.

Note that the illustrated components of computing device 802 are not required or all-inclusive, and fewer or greater numbers of components may be present as would be recognized by one skilled in the art. For example, computing device 802 may also include one or more of a gyroscope, barometer, proximity sensor, ambient light sensor, digital compass, etc. Processor 810 and memory 856 may be co-located in a same semiconductor device package, such as being included together in an integrated circuit chip, FPGA, or system-on-chip (SOC), optionally along with further components of computing device 802.

In embodiments, computing device 802 is configured to implement any of the above-described features of flowcharts herein. Computer program logic for performing any of the operations, steps, and/or functions described herein may be stored in storage 820 and executed by processor 810.

In some embodiments, server infrastructure 870 may be present in computing environment 800 and may be communicatively coupled with computing device 802 via network 804. Server infrastructure 870, when present, may be a network-accessible server set (e.g., a cloud-based environment or platform). As shown in FIG. 8, server infrastructure 870 includes clusters 872. Each of clusters 872 may comprise a group of one or more compute nodes and/or a group of one or more storage nodes. For example, as shown in FIG. 8, cluster 872 includes nodes 874. Each of nodes 874 are accessible via network 804 (e.g., in a “cloud-based” embodiment) to build, deploy, and manage applications and services. Any of nodes 874 may be a storage node that comprises a plurality of physical storage disks, SSDs, and/or other physical storage devices that are accessible via network 804 and are configured to store data associated with the applications and services managed by nodes 874. For example, as shown in FIG. 8, nodes 874 may store application data 878.

Each of nodes 874 may, as a compute node, comprise one or more server computers, server systems, and/or computing devices. For instance, a node 874 may include one or more of the components of computing device 802 disclosed herein. Each of nodes 874 may be configured to execute one or more software applications (or “applications”) and/or services and/or manage hardware resources (e.g., processors, memory, etc.), which may be utilized by users (e.g., customers) of the network-accessible server set. For example, as shown in FIG. 8, nodes 874 may operate application programs 876. In an implementation, a node of nodes 874 may operate or comprise one or more virtual machines, with each virtual machine emulating a system architecture (e.g., an operating system), in an isolated manner, upon which applications such as application programs 876 may be executed.

In an embodiment, one or more of clusters 872 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 872 may be a datacenter in a distributed collection of datacenters. In embodiments, exemplary computing environment 800 comprises part of a cloud-based platform such as Amazon Web Services® of Amazon Web Services, Inc. or Google Cloud Platform™ of Google LLC, although these are only examples and are not intended to be limiting.

In an embodiment, computing device 802 may access application programs 876 for execution in any manner, such as by a client application and/or a browser at computing device 802. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 802 may additionally and/or alternatively synchronize copies of application programs 814 and/or application data 816 to be stored at network-based server infrastructure 870 as application programs 876 and/or application data 878. For instance, operating system 812 and/or application programs 814 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 820 at network-based server infrastructure 870.

In some embodiments, on-premises servers 892 may be present in computing environment 800 and may be communicatively coupled with computing device 802 via network 804. On-premises servers 892, when present, are hosted within an organization's infrastructure and, in many cases, physically onsite of a facility of that organization. On-premises servers 892 are controlled, administered, and maintained by IT (Information Technology) personnel of the organization or an IT partner to the organization. Application data 898 may be shared by on-premises servers 892 between computing devices of the organization, including computing device 802 (when part of an organization) through a local network of the organization, and/or through further networks accessible to the organization (including the Internet). Furthermore, on-premises servers 892 may serve applications such as application programs 896 to the computing devices of the organization, including computing device 802. Accordingly, on-premises servers 892 may include storage 894 (which includes one or more physical storage devices such as storage disks and/or SSDs) for storage of application programs 896 and application data 898 and may include one or more processors for execution of application programs 896. Still further, computing device 802 may be configured to synchronize copies of application programs 814 and/or application data 816 for backup storage at on-premises servers 892 as application programs 896 and/or application data 898.

Embodiments described herein may be implemented in one or more of computing device 802, network-based server infrastructure 870, and on-premises servers 892. For example, in some embodiments, computing device 802 may be used to implement systems, clients, or devices, or components/subcomponents thereof, disclosed elsewhere herein. In other embodiments, a combination of computing device 802, network-based server infrastructure 870, and/or on-premises servers 892 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 820. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 814) may be stored in storage 820. Such computer programs may also be received via wired interface(s) 880 and/or wireless modem(s) 860 over network 804. Such computer programs, when executed or loaded by an application, enable computing device 802 to implement features of embodiments discussed herein. Accordingly, such computer programs represent controllers of the computing device 802.

Embodiments are also directed to computer program products comprising computer code or instructions stored on any computer-readable medium or computer-readable storage medium. Such computer program products include the physical storage of storage 820 as well as further physical storage types.

### IV. Additional Example Embodiments

In an embodiment, a method for augmenting a large language model includes receiving a query; generating a first feature vector based on the query; comparing the first feature vector to a plurality of second feature vectors, each of the plurality of second feature vectors corresponding to a piece of augmentation information; determining second feature vectors that satisfy a predetermined condition with respect to the first feature vector; retrieving pieces of augmentation information corresponding to the determined subset of second feature vectors; providing, to the large language model, an augmented prompt generated based at least on the query and the retrieved pieces of augmentation information; and receiving a response generated by the large language model.

In an embodiment, the method further includes: providing a user interface for querying domain-specific information, wherein the query is received from a user through the user interface; and providing the response to the user through the user interface, wherein the response is generated by the large language model based on domain-specific information contained in the retrieved pieces of augmentation information.

In an embodiment, comparing the first feature vector to the plurality of second feature vectors comprises: determining cosine similarities between at least a portion of the first feature vector and corresponding portions of the plurality of second feature vectors.

In an embodiment, determining second feature vectors that satisfy a predetermined condition with respect to the first feature vector comprises: determining the second feature vectors having a cosine similarity to the first feature vector that satisfies a first predetermined relationship with a first predetermined threshold; determining a first predetermined number of second feature vectors having the highest cosine similarities to the first feature vector; or determining a second predetermined number of second feature vectors having the highest cosine similarities to the first feature vector that satisfy a second predetermined relationship with a second predetermined threshold.

In an embodiment, the augmented prompt comprises: a request for a response to the query based at least on the retrieved pieces of augmentation information; and the retrieved augmentation information.

In an embodiment, generating the first feature vector comprises: encoding the query into a low-dimensional dense vector using a Generative Pre-Trained Transformer (GPT)-based or a Bidirectional Encoder Representations from Transformers (BERT)-based encoder, and wherein said second feature vectors are generated by encoding the pieces of augmentation information into low-dimensional dense vectors using the GPT-based or the BERT-based encoder.

In an embodiment, the user contextual information comprises at least one of: domain-specific information; entity-specific information; product-specific information; recent information unavailable at generation of the large language model; or information changed after generation of the large language model.

In an embodiment, the method further includes receiving files containing augmentation information; pre-processing the files to generate processed augmentation information; tokenizing the processed augmentation information to generate tokenized augmentation information; and generating the plurality of second feature vectors based on the tokenized augmentation information.

In an embodiment, a system for augmenting a large language model includes: a processor; and a memory device that stores program code structured to cause the processor to: receive a query; generate a first feature vector based on the query; compare the first feature vector to a plurality of second feature vectors to determine a subset of the second feature vectors that satisfy a predetermined condition; retrieve the pieces of augmentation information corresponding to the determined subset of second feature vectors; provide, to the large language model, an augmented prompt generated based at least on the query and the retrieved pieces of augmentation information; and receive a response generated by the large language model.

In an embodiment, the program code is further structured to cause the processor to: provide a user interface for querying domain-specific information, wherein the query is received from a user through the user interface; and provide the response to the user through the user interface, wherein the response is generated by the large language model based on domain-specific information contained in the retrieved pieces of augmentation information.

In an embodiment, wherein to compare the first feature vector to a plurality of second feature vectors to determine second feature vectors that satisfy a predetermined condition with respect to the first feature vector, the program code is further structured to cause the processor to: determine cosine similarities between at least a portion of the first feature vector and corresponding portions of the plurality of second feature vectors.

In an embodiment, wherein to compare the first feature vector to a plurality of second feature vectors to determine second feature vectors that satisfy a predetermined condition with respect to the first feature vector, the program code is further structured to cause the processor to: determine the second feature vectors having a cosine similarity to the first feature vector that satisfies a first predetermined relationship with a first predetermined threshold; determine a first predetermined number of second feature vectors having the highest cosine similarities to the first feature vector; or determine a second predetermined number of second feature vectors having the highest cosine similarities to the first feature vector that satisfy a second predetermined relationship with a second predetermined threshold.

In an embodiment, the augmented prompt comprises: a request for a response to the query based at least on the retrieved pieces of augmentation information; and the retrieved augmentation information.

In an embodiment, generating the first feature vector comprises: encoding the query into a low-dimensional dense vector using a Generative Pre-Trained Transformer (GPT)-based or a Bidirectional Encoder Representations from Transformers (BERT)-based encoder, and wherein said second feature vectors are generated by encoding the pieces of augmentation information into low-dimensional dense vectors using the GPT-based or the BERT-based encoder.

In an embodiment, the user contextual information comprises at least one of: domain-specific information; entity-specific information; product-specific information; recent information unavailable at generation of the large language model; or information changed after generation of the large language model.

In an embodiment, wherein the program code is further structured to cause the processor to: receive files containing augmentation information; pre-process the files to generate processed augmentation information; tokenize the processed augmentation information to generate tokenized augmentation information; and generate the plurality of second feature vectors based on the tokenized augmentation information.

In an embodiment, a computer-readable storage medium comprising computer-executable instructions, that when executed by a processor, cause the processor to: receive a query; generate a first feature vector based on the query; compare the first feature vector to a plurality of second feature vectors to determine a subset of the second feature vectors that satisfy a predetermined condition; retrieve the pieces of augmentation information corresponding to the determined subset of second feature vectors; provide, to the large language model, an augmented prompt generated based at least on the query and the retrieved pieces of augmentation information; and receive a response generated by the large language model.

In an embodiment, the instructions, when executed by the processor, further causes the processor to: provide a user interface for querying domain-specific information, wherein the query is received from a user through the user interface; and provide the response to the user through the user interface, wherein the response is generated by the large language model based on domain-specific information contained in the retrieved pieces of augmentation information.

In an embodiment, compare the first feature vector to the plurality of second feature vectors comprises: determine cosine similarities between at least a portion of the first feature vector and corresponding portions of the plurality of second feature vectors.

In an embodiment, determine second feature vectors that satisfy a predetermined condition with respect to the first feature vector comprises: determine the second feature vectors having a cosine similarity to the first feature vector that satisfies a first predetermined relationship with a first predetermined threshold; determine a first predetermined number of second feature vectors having the highest cosine similarities to the first feature vector; or determine a second predetermined number of second feature vectors having the highest cosine similarities to the first feature vector that satisfy a second predetermined relationship with a second predetermined threshold.

In an embodiment, the augmented prompt comprises: a request for a response to the query based at least on the retrieved pieces of augmentation information; and the retrieved augmentation information.

In an embodiment, generate the first feature vector comprises: encode the query into a low-dimensional dense vector using a Generative Pre-Trained Transformer (GPT)-based or a Bidirectional Encoder Representations from Transformers (BERT)-based encoder, and wherein said second feature vectors are generated by encoding the pieces of augmentation information into low-dimensional dense vectors using the GPT-based or the BERT-based encoder.

In an embodiment, the user contextual information comprises at least one of: domain-specific information; entity-specific information; product-specific information; recent information unavailable at generation of the large language model; or information changed after generation of the large language model.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed:

1. A method for augmenting a large language model, comprising:
receiving a query;
generating a first feature vector based on the query;
comparing the first feature vector to a plurality of second feature vectors, each of which corresponding to a piece of augmentation information, to determine second feature vectors that satisfy a predetermined condition with respect to the first feature vector;
retrieving pieces of augmentation information corresponding to the determined subset of second feature vectors;
providing, to the large language model, an augmented prompt generated based at least on the query and the retrieved pieces of augmentation information; and
receiving a response generated by the large language model.

2. The method of claim 1, further comprising:
providing a user interface for querying domain-specific information, wherein the query is received from a user through the user interface; and
providing the response to the user through the user interface, wherein the response is generated by the large language model based on domain-specific information contained in the retrieved pieces of augmentation information.

3. The method of claim 1, wherein said comparing the first feature vector to the plurality of second feature vectors comprises:
determining cosine similarities between at least a portion of the first feature vector and corresponding portions of the plurality of second feature vectors.

4. The method of claim 3, wherein said comparing the first feature vector to a plurality of second feature vectors, each of which corresponding to a piece of augmentation information, to determine second feature vectors that satisfy a predetermined condition with respect to the first feature vector comprises:
determining the second feature vectors having a cosine similarity to the first feature vector that satisfies a first predetermined relationship with a first predetermined threshold;
determining a first predetermined number of second feature vectors having highest cosine similarities to the first feature vector; or
determining a second predetermined number of second feature vectors having highest cosine similarities to the first feature vector that satisfy a second predetermined relationship with a second predetermined threshold.

5. The method of claim 1, wherein the augmented prompt comprises:
a request for a response to the query based at least on the retrieved pieces of augmentation information; and
the retrieved pieces of augmentation information.

6. The method of claim 1, wherein said generating the first feature vector comprises:
encoding the query into a low-dimensional dense vector using a Generative Pre-Trained Transformer (GPT)-based or a Bidirectional Encoder Representations from Transformers (BERT)-based encoder, and
wherein said second feature vectors are generated by encoding the pieces of augmentation information into low-dimensional dense vectors using the GPT-based or the BERT-based encoder.

7. The method of claim 1, wherein the pieces of augmentation information comprise at least one of:
domain-specific information;
entity-specific information;
product-specific information;
recent information unavailable at generation of the large language model; or
information changed after generation of the large language model.

8. A system for augmenting a large language model, comprising:
a processor;
a memory device that stores program code structured to cause the processor to:
receive a query;
generate a first feature vector based on the query;
compare the first feature vector to a plurality of second feature vectors, each of which corresponding to a piece of augmentation information, to determine second feature vectors that satisfy a predetermined condition with respect to the first feature vector;
retrieve the pieces of augmentation information corresponding to the determined subset of second feature vectors;
provide, to the large language model, an augmented prompt generated based at least on the query and the retrieved pieces of augmentation information; and
receive a response generated by the large language model.

9. The system of claim 8, wherein the program code is further structured to cause the processor to:
provide a user interface for querying domain-specific information, wherein the query is received from a user through the user interface; and
provide the response to the user through the user interface, wherein the response is generated by the large language model based on domain-specific information contained in the retrieved pieces of augmentation information.

10. The system of claim 8, wherein to compare the first feature vector to a plurality of second feature vectors to determine second feature vectors that satisfy a predetermined condition with respect to the first feature vector, the program code is further structured to cause the processor to:
determine cosine similarities between at least a portion of the first feature vector and corresponding portions of the plurality of second feature vectors.

11. The system of claim 10, wherein to compare the first feature vector to a plurality of second feature vectors to determine second feature vectors that satisfy a predetermined condition with respect to the first feature vector, the program code is further structured to cause the processor to:
determine the second feature vectors having a cosine similarity to the first feature vector that satisfies a first predetermined relationship with a first predetermined threshold;
determine a first predetermined number of second feature vectors having highest cosine similarities to the first feature vector; or
determine a second predetermined number of second feature vectors having highest cosine similarities to the first feature vector that satisfy a second predetermined relationship with a second predetermined threshold.

12. The system of claim 8, wherein the augmented prompt comprises:
a request for a response to the query based at least on the retrieved pieces of augmentation information; and
the retrieved pieces of augmentation information.

13. The system of claim 8, wherein to generate the first feature vector, the program code is further structured to cause the processor to:
encode the query into a low-dimensional dense vector using a Generative Pre-Trained Transformer (GPT)-based or a Bidirectional Encoder Representations from Transformers (BERT)-based encoder, and wherein said second feature vectors are generated by encoding the pieces of augmentation information into low-dimensional dense vectors using the GPT-based or the BERT-based encoder.

14. The system of claim 8, wherein the pieces of augmentation information comprise at least one of:
domain-specific information;
entity-specific information;
product-specific information;
recent information unavailable at generation of the large language model; or information changed after generation of the large language model.

15. A computer-readable storage medium comprising computer-executable instructions, that when executed by a processor, cause the processor to:
receive a query;
generate a first feature vector based on the query;
compare the first feature vector to a plurality of second feature vectors, each of which corresponding to a piece of augmentation information, to determine second feature vectors that satisfy a predetermined condition with respect to the first feature vector;
retrieve the pieces of augmentation information corresponding to the determined subset of second feature vectors;
provide, to the large language model, an augmented prompt generated based at least on the query and the retrieved pieces of augmentation information; and
receive a response generated by the large language model.

16. The computer-readable storage medium of claim 15, wherein the instructions, when executed by the processor, further cause the processor to:
provide a user interface for querying domain-specific information, wherein the query is received from a user through the user interface; and
provide the response to the user through the user interface, wherein the response is generated by the large language model based on domain-specific information contained in the retrieved pieces of augmentation information.

17. The computer-readable storage medium of claim 15, wherein said compare the first feature vector to the plurality of second feature vectors comprises:
determine cosine similarities between at least a portion of the first feature vector and corresponding portions of the plurality of second feature vectors.

18. The computer-readable storage medium of claim 17, wherein said determine second feature vectors that satisfy a predetermined condition with respect to the first feature vector comprises:
determine the second feature vectors having a cosine similarity to the first feature vector that satisfies a first predetermined relationship with a first predetermined threshold;
determine a first predetermined number of second feature vectors having highest cosine similarities to the first feature vector; or
determine a second predetermined number of second feature vectors having highest cosine similarities to the first feature vector that satisfy a second predetermined relationship with a second predetermined threshold.

19. The computer-readable storage medium of claim 15, wherein the augmented prompt comprises:
a request for a response to the query based at least on the retrieved pieces of augmentation information; and
the retrieved pieces of augmentation information.

20. The computer-readable storage medium of claim 15, wherein said generate the first feature vector comprises:
encode the query into a low-dimensional dense vector using a Generative Pre-Trained Transformer (GPT)-based or a Bidirectional Encoder Representations from Transformers (BERT)-based encoder, and
wherein said second feature vectors are generated by encoding the pieces of augmentation information into low-dimensional dense vectors using the GPT-based or the BERT-based encoder.
